(19) United States
(12) Patent Application Publication
(10) Pub. No.: US 2010/0165298 A1
(43) Pub. Date: Jul. 1, 2010

(54) ILLUMINATION APPARATUS AND IMAGE PROJECTION DISPLAY APPARATUS

(75) Inventor: Shinichi Imade, Saitama (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: Olympus Corporation

(21) Appl. No.: 12/601,336

(22) PCT Filed: Apr. 25, 2008
(86) PCT No.: PCT/JP08/58022

§ 371 Date: Nov. 23, 2009

(30) Foreign Application Priority Data
May 30, 2007 (JP) 2007-143273

(51) Int. Cl. G03B 21/14; F21V 1/00

(52) U.S. Cl. 353/31; 362/235

(57) ABSTRACT

An illumination apparatus and an image projection display apparatus are provided that are capable of stably obtaining a large amount of illumination light and capable of efficiently using the light emitted from light sources as illumination light. Provided are a plurality of light sources (2) that are arranged in an arc and that emit illumination light toward the axis (L) of the arc; and light guiding means (3) having an entrance end (31) that faces the plurality of light sources (2) and that is formed in a concave surface shape having the focal point on the axis (L) and an exit end (33) from which the illumination light is emitted.

### TECHNICAL FIELD

The present invention relates to illumination apparatuses and image projection display apparatuses that use a plurality of light sources capable of fast pulsed lighting, such as LEDs, that guide light emitted from the plurality of light sources to a common integrated direction, and that produce high-power, highly-directional illumination light.

### BACKGROUND ART

In recent years, light emission efficiency in semiconductor light sources, such as LEDs (light-emitting diodes) and semiconductor lasers, has been improved, and the expression of three primary colors of RGB (red, green, and blue) using the semiconductor light sources has been put to practical use. Therefore, semiconductor light sources have been employed as illumination light sources for image display systems such as large-screen liquid crystal televisions and projectors, applications that were therefore considered to be difficult because of the low brightness.

The above-mentioned semiconductor light sources have many advantages in that a wide range of colors can be displayed because the emitted light has a narrow wavelength range and high color purity; instantaneous lighting is enabled because of the high responsiveness; the frequency of replacement of the light sources is low because of their long lives; and environmental handling is easy because mercury is not used. Therefore, they are expected to be adopted as means for solving problems inherent to conventional lamp light sources.

However, semiconductor light sources do not have enough brightness compared with the conventional lamp light sources. Thus, a plurality of semiconductor light sources are used to obtain a required amount of light.

In particular, in the case of projector light sources, the display device is small and thus the angle of light beam to be effectively used is limited. Therefore, light sources capable of illuminating a small area and of emitting highly directional illumination light are required.

On that point, laser light sources are preferable as projector light sources because they can emit light having extremely-high directivity and can illuminate a small area with a large amount of light when a number of laser light sources are used. However, laser light sources that emit high-power laser light have a problem in terms of visual safety when used for image display apparatuses, such as projectors.

On the other hand, there is no problem of visual safety when LEDs are used as projector light sources. However, since LEDs are surface-emitting diffuse-light sources, the total light-emitting area is increased in order to obtain a large amount of light by using a number of LEDs.

This LED usage has a problem in that it is difficult in principle to generate highly directional effective illumination light, that is, illumination light required for projectors, with a small area because of the so-called etendu conservation law.

Various technologies have been proposed that solve the above-described problems to obtain high-brightness illumination light by using semiconductor light sources or the like that have high lighting responsiveness and from which a large amount of light can be instantaneously extracted with pulsed lighting. Some of the technologies will be described below.

For example, configurations have been proposed in which a plurality of semiconductor lasers or LEDs are fixedly arranged in a circle and a reflecting mirror that rotates in one direction is disposed at the center of the circle. In those configurations, laser light or the like is emitted from the individual semiconductor laser or the like in synchronization with the rotation of the reflecting mirror (see Patent Documents 1 and 2, for example).

By doing so, an increase in light-emitting area is inhibited, and the semiconductor lasers or the like are powered by pulses to increase the amount of emitted light. Therefore, with the configurations described in Patent Documents 1 and 2, illumination light having high directivity and high brightness can be obtained.

On the other hand, a configuration has been proposed that includes a plurality of light-emitting diodes arranged in directions such that their emitted light beams cross each other in a predetermined area, and a rotating mirror disposed in the predetermined area. With this configuration, the angle of rotation of the mirror is controlled, thereby guiding illumination light emitted from the plurality of light-emitting diodes in the same direction (see Patent Document 3, for example).

Further, a configuration has been proposed in which a plurality of light-emitting diodes arranged in a circle are arranged so as to emit light in one direction and a light collection optical system for guiding the emitted light is disposed facing one of the light-emitting diodes. With this configuration, the light-emitting diodes are rotated about the center of the circle, and light is emitted from the light-emitting diode that faces the light collection optical system. By doing so, the light-emitting diodes can be sequentially driven by pulses to obtain high-brightness illumination light (see Patent Document 4, for example).

Patent Document 1:
Japanese Unexamined Patent Application, Publication No. 10-293233

Patent Document 2:
Japanese Unexamined Patent Application, Publication No. 2004-199024

Patent Document 3:
Japanese Unexamined Patent Application, Publication No. 2003-208991

Patent Document 4:
Japanese Unexamined Patent Application, Publication No. 2003-24275

### DISCLOSURE OF INVENTION

The above-mentioned technologies described in Patent Documents 1 to 4 are useful as methods of generating high-brightness illumination light.

However, small temporal and spatial variations in the amount of light are further required in order to use the light as illumination light for image display systems such as projectors. The technologies described in the above patent documents do not satisfy this requirement.

Specifically, with the technologies described in Patent Documents 1 and 2, when the semiconductor laser or the like and the reflecting mirror are arranged so as to face each other, laser light or the like emitted from the semiconductor laser or the like is successfully guided to an illumination object. However, when the reflecting mirror is rotated and faces the area between adjacent semiconductor lasers, the light emitted from the semiconductor lasers or the like is reflected by the reflecting mirror in a direction different from that toward the illumination object.

In other words, the amount of illumination light for illuminating the illumination object varies depending on the positional relationship between the semiconductor laser or the like and the reflecting mirror, thus causing a problem in that a stable amount of illumination light cannot be obtained.

With the technology described in Patent Document 3, the amount of illumination light to be guided to the illumination object is reduced during a period of time when the mirror is switched from a rotational position where light emitted from one light-emitting diode is guided to the illumination object to a rotational position where light emitted from another light-emitting diode is guided to the illumination object. Therefore, a stable amount of illumination light cannot be obtained.

With the technology described in Patent Document 4, in a state where the light collection optical system is positioned between adjacent light-emitting diodes, light emitted from the light-emitting diodes does not enter the light collection optical system and the amount of illumination light guided to the illumination object is reduced. Therefore, a stable amount of illumination light cannot be obtained.

An object of the present invention is to provide an illumination apparatus and an image projection display apparatus capable of stably obtaining a large amount of illumination light and capable of efficiently using light emitted from light sources as illumination light.

In order to achieve the above-mentioned object, the present invention provides the following solutions.

According to a first aspect, the present invention provides an illumination apparatus including: a plurality of light sources that are arranged in an arc and that emit illumination light toward the axis of the arc; and light guiding means having an entrance end that faces the plurality of light sources and that is formed in a concave surface shape having a focal point on the axis and an exit end from which the illumination light is emitted.

According to the first aspect of the present invention, illumination light beams emitted from the plurality of light sources travel toward the axis of the arc and enter the entrance end of the light guiding means disposed facing the light sources. Since the entrance end is formed in a concave surface shape having the focal point on the axis, the illumination light beams entering from the entrance end are substantially collimated through refraction by the entrance end. Therefore, according to the illumination apparatus of the present invention, it is possible to emit highly directional illumination light from the exit end of the light guiding means.

Further, since the plurality of light sources are arranged in an arc, it is possible to allow illumination light emitted from more light sources to enter the entrance end having the same area, to increase the amount of illumination light emitted from the exit end compared with a case where they are arranged linearly.

In the first aspect of the present invention, it is desirable to further include reflecting parts that face end surfaces of the light guiding means in the axis direction, that extend from the entrance end toward the light sources, and whose surfaces facing the light guiding means serve as reflecting surfaces for reflecting light.

By doing so, among illumination light emitted from the light sources, illumination light leaking from between the light sources and the entrance end in the axis direction is reflected by the reflecting parts and is guided to the entrance end. Therefore, compared with a case where the reflecting parts are not provided, it is possible to suppress optical loss occurring from the light sources to the exit end to increase the amount of the emitted illumination light.

In the first aspect of the present invention, it is desirable to have a structure in which: the plurality of light sources are arranged in a circle with the axis serving as the center; the light guiding means is provided with a prism that is disposed at a location on the axis and that reflects the illumination light entering from the entrance end, in the axis direction; and rotating means that rotationally drives the light guiding means about the axis is provided.

By doing so, the light guiding means is rotationally driven about the axis, thereby switching and changing over the light sources that face the entrance end at high speed. Illumination light emitted from the light sources that face the entrance end enters the light guiding means from the entrance end. The illumination light entering the light guiding means from the entrance end is reflected by the prism in the axis direction and is emitted from the exit end in the axis direction.

Since the light sources that face the entrance end are switched and changed over at high speed, it is possible to suppress variations of illumination light occurring during the switching and changeover to generate stable illumination light in which optical loss is low when guided from the light sources in the direction of illumination.

In the above-described structure, it is desirable to further include reflecting parts that face end surfaces of the light guiding means in the axis direction, that extend from the entrance end toward the light sources, and whose surfaces facing the light guiding means serve as reflecting surfaces for reflecting light, in which the rotating means rotationally drives the reflecting parts together with the light guiding means.

By doing so, since the reflecting parts are also rotationally driven together with the light guiding means, illumination light leaking in the axis direction from between the entrance end that is rotating and the light sources that face the entrance end can be reflected by the reflecting parts and guided to the entrance end.

In the above-described structure, it is desirable to further include reflecting parts that face end surfaces of the light guiding means in the axis direction, that extend from the entrance end toward the light sources in the form of a ring plate, and whose surfaces facing the light guiding means serve as reflecting surfaces for reflecting light.

By doing so, since the reflecting parts are formed in a ring-plate-like shape, illumination light leaking in the axis direction from between the entrance end that is rotating and the light sources that face the entrance end can be reflected by the reflecting parts and guided to the entrance end.

In the above-described structure, it is desirable that the light sources be turned on only during a period of time when they face the entrance end.

By doing so, the light sources can be turned on only during a period of time when they face the entrance end and can be turned off during the other periods: in other words, they can be driven by pulses to emit light.

For example, by using light sources that can emit a larger amount of illumination light when driven by pulses to emit light as LEDs than in a case where they are driven by direct current, the illumination apparatus of the present invention can emit a large amount of illumination light without increasing the emission area.

In the first aspect of the present invention, it is desirable that the light sources each have a light emitting part for emitting illumination light and a tapered rod for guiding the emitted light toward the entrance end.

By doing so, since the light emitting part and the tapered rod are provided, the illumination light emitted from the light emitting part can be guided to the entrance end while suppressing optical loss through the collimation effect and total reflection effect of the tapered rod.

Further, compared with a case where the tapered rod is not used, illumination light emitted from the light emitting part can be collimated more, to be guided to the entrance end.

In the first aspect of the present invention, it is desirable that the entrance end have a cylindrical lens.

By doing so, even when the plurality of light sources are arranged in an arc or circle and are also arranged along the axis, illumination light emitted toward the axis is substantially collimated through refraction by the entrance end.

In the first aspect of the present invention, it is desirable that the light guiding means be provided with the entrance end and a parallel rod that guides illumination light to the exit end.

Providing the parallel rod in this way allows the illumination light entering from the entrance end to be guided to the exit end while suppressing the optical loss through the total reflection effect.

According to a second aspect, the present invention provides an image projection display apparatus including: a plurality of illumination apparatuses according to the first aspect of the present invention that respectively emit light of different primary colors; display devices that modulate the illumination light emitted from the illumination apparatuses based on input image data; and projection optics means that projects the modulated illumination light on a screen.

According to the second aspect of the present invention, the illumination apparatuses of the present invention are used, thereby making it possible to stably illuminate the display devices with illumination light having high directivity, high intensity, and low variations in the amount of light. Therefore, a bright image with good contrast can be projected on the screen.

Note that, in the second aspect of the present invention, an illumination apparatus according to the first aspect of the present invention that emits white light may be used instead of the plurality of illumination apparatuses according to the first aspect of the present invention that respectively emit light of different primary colors.

Also when the illumination apparatus according to the first aspect of the present invention that emits white light is used, a bright image with good contrast can be obtained.

According to the illumination apparatus of the first aspect of the present invention and the image projection display apparatus of the second aspect of the present invention, since the entrance end is formed in a concave surface shape having a focal point on the axis, an advantage is afforded in that illumination light entering from the entrance end is substantially collimated, and thus the light emitted from the light sources can be efficiently used as illumination light.

Since the plurality of light sources are arranged in an arc, an advantage is afforded in that a large amount of illumination light can be stably obtained.

### BRIEF DESCRIPTION OF DRAWINGS

FIG. 1 is a schematic view for explaining the structure of, an illumination apparatus according to one embodiment of the present invention.

FIG. 2 is a block diagram for explaining the structure of the illumination apparatus shown in FIG. 1.

FIG. 3 is a partially enlarged view for explaining the structure of basic members in each light source unit shown in FIG. 1.

FIG. 4 is a top view for explaining the structure of the illumination apparatus shown in FIG. 1.

FIG. 5 is a partially enlarged view for explaining the structure of an entrance end shown in FIG. 1.

FIG. 6 is a schematic view for explaining a case where light source units are arranged on a plane.

FIG. 7 is a schematic view for explaining a sequence for turning on the light source units shown in FIG. 1.

FIG. 8 is a graph for explaining the sequence for turning on the light source units shown in FIG. 1.

FIG. 9 is a schematic view for explaining another embodiment of the illumination apparatus shown in FIG. 1.

FIG. 10 is a top view for explaining an illumination apparatus shown in FIG. 9 according to the other embodiment.

FIG. 11 is a schematic view for explaining the structure of an illumination apparatus according to a second embodiment of the present invention.

FIG. 12 is a top view for explaining the structure of the illumination apparatus shown in FIG. 11.

FIG. 13 is a partially enlarged view for explaining the structure of an entrance end of a light guiding unit shown in FIG. 11.

FIG. 14 is a schematic view for explaining the structure of a projector according to a third embodiment of the present invention.

### EXPLANATION OF REFERENCE SIGNS

1, 101, 1R, 1G, 1B: illumination apparatus
2, 102: light source unit (light source)
3, 103: light guiding unit (light guiding means)
4: driving part (rotating means)
5, 5A: reflection plate (reflecting part)
22, 22R, 22G, 22B: LED (light emitting part)
23: tapered rod
31: entrance end
32: parallel rod
33: exit end
34: right-angled prism (prism)
201: projector
202R, 202G, 202B: liquid crystal display device (display device)
204: projector lens (projection optics means)
L: axis

### BEST MODE FOR CARRYING OUT THE INVENTION

### First Embodiment

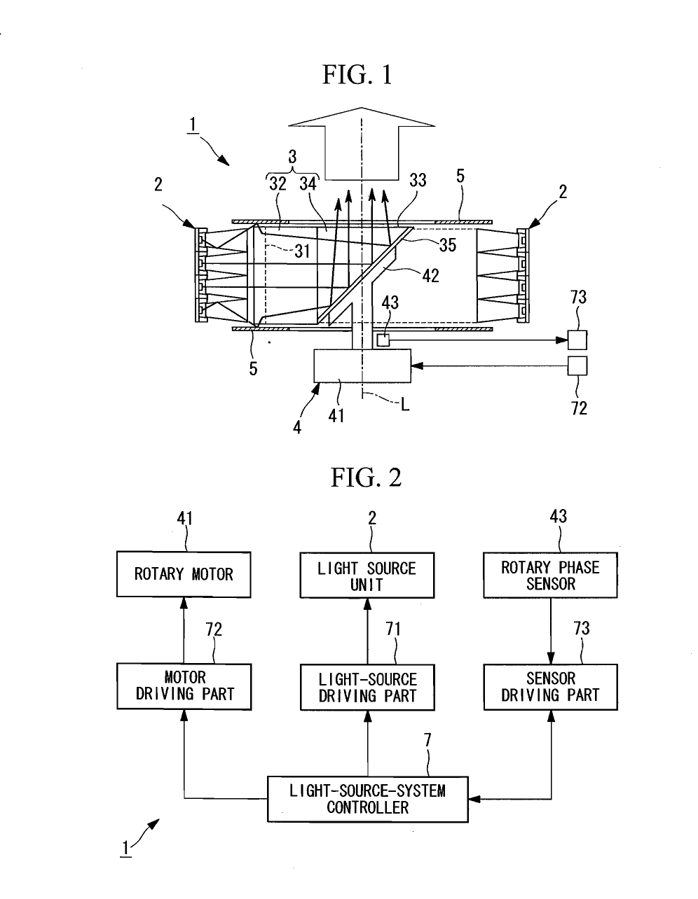

An illumination apparatus according to a first embodiment of the present invention will be described below with reference to FIGS. 1 to 10.

FIG. 1 is a schematic view for explaining the structure of the illumination apparatus according to this embodiment. FIG. 2 is a block diagram for explaining the structure of the illumination apparatus shown in FIG. 1.

As shown in FIGS. 1 and 2, an illumination apparatus 1 includes a plurality of light source units (light sources) 2 that emit illumination light, a light guiding unit (light guiding means) 3 that guides the emitted illumination light, a driving part (rotating means) 4 that rotationally drives the light guiding unit 3, reflection plates (reflecting parts) 5 that reflect to the light guiding unit 3 illumination light leaking from the light source units 2, and a light-source-system controller 7 that controls the light source units 2 and the driving part 4.

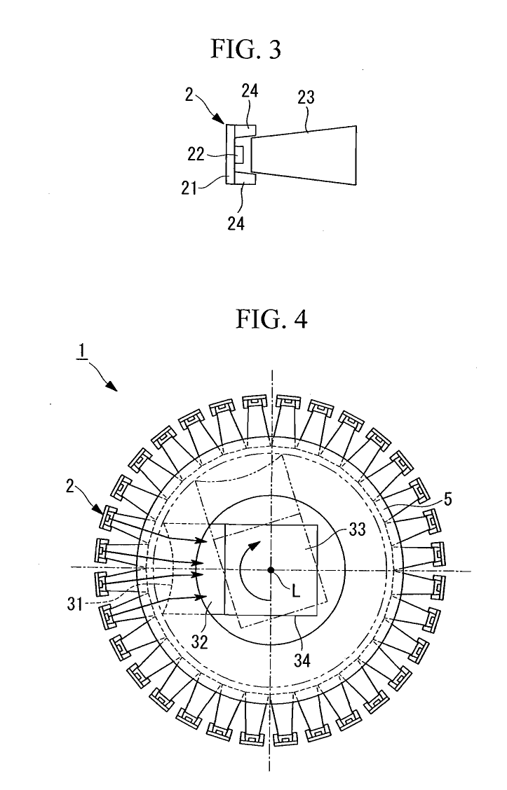

FIG. 3 is a partially enlarged view for explaining the structure of basic members in each of the light source units shown in FIG. 1.

As shown in FIG. 3, the light source unit 2 includes a substrate 21 on which an LED 22 etc. are disposed, the LED (light emitting part) 22 that emits illumination light, tapered rod 23 that guides to the light guiding unit 3 the illumination light emitted from the LED 22, and reflecting members 24 that reflect toward the tapered rod 23 the illumination light emitted from the LED 22.

The LED 22 is a surface-emitting diffuse-light source that emits illumination light based on power supplied by a light-source driving part 71 to be described later. The LED 22 is disposed between the substrate 21 and the tapered rod 23.

The tapered rod 23 guides to the light guiding unit 3 the illumination light emitted from the LED 22 and also collimates the illumination light, which is diffuse light, emitted from the LED 22. The tapered rod 23 is disposed between the LED 22 and the light guiding unit 3 such that an entrance end thereof having a small area faces the LED 22 and an exit end thereof having a large area faces the light guiding unit 3.

Note that a parallel rod whose entrance end and exit end have the same area may be used instead of the tapered rod 23; the type of the rod is not particularly limited.

Among the illumination light emitted from the LED 22, the reflecting members 24 reflect, toward the tapered rod 23, light traveling toward the outside from between the LED 22 and the tapered rod 23. The reflecting members 24 are located adjacent to the LED 22 and extend from the LED 22 toward the tapered rod 23. Surfaces of the reflecting members 24 that face the LED 22 serve as reflecting surfaces for reflecting the illumination light.

FIG. 4 is a top view for explaining the structure of the illumination apparatus shown in FIG. 1.

As shown in FIGS. 1 and 4, the light source units 2 are arranged in a circle centered on the axis L (see FIG. 4) and are arranged along the axis L (see FIG. 1). In other words, they are arrayed on the cylindrical surface with the axis L serving as the central axis. In this embodiment, a description will be given of a state where the light source units 2 are arrayed in 4 rows along the axis L and 32 columns on the circumference of the circle.

As shown in FIGS. 1 and 4, the light guiding unit 3 includes a parallel rod 32 provided with an entrance end 31 and a right-angled prism (prism) 34 provided with an exit end 33.

The parallel rod 32 guides to the right-angled prism 34 illumination light emitted from the light source units 2 that face the entrance end 31. The parallel rod 32 is disposed so as to extend from the right-angled prism 34 toward the light source units 2 and is rotated together with the right-angled prism 34.

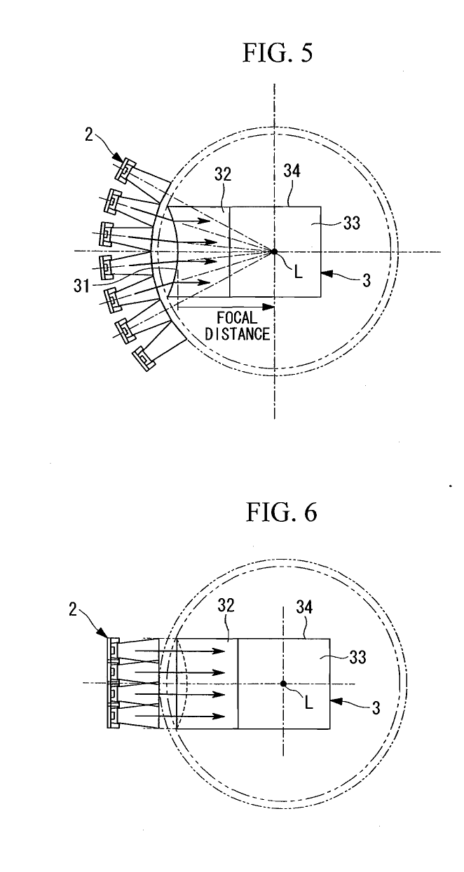

FIG. 5 is a partially enlarged view for explaining the structure of the entrance end shown in FIG. 1.

At an end of the parallel rod 32 facing the light source units 2, the entrance end 31 is formed, which illumination light emitted from the light source units 2 facing the end enters. As shown in FIG. 5, the entrance end 31 is formed to have a concave-curved surface having a focal point on the axis L, in other words, it is formed in a cylindrical lens shape.

As shown in FIG. 1, the right-angled prism 34 is a right-angled triangular prism that reflects the illumination light guided by the parallel rod 32, in a direction along the axis L. The right-angled prism 34 is disposed on a holding part 42 of the driving part 4 disposed on the axis L.

The right-angled prism 34 is formed to have two faces that are perpendicular to each other and an inclined face sandwiched between these faces. Of the two faces that are perpendicular to each other, one face faces the light source units 2, and the parallel rod 32 is disposed adjacent thereto. The other face is substantially perpendicular to the axis L and serves as the exit end 33 from which the illumination light guided by the parallel rod 32 and the right-angled prism 34 is emitted. The inclined face is provided with a reflective coating 35 that reflects the illumination light, and the holding part 42 is brought into contact with the inclined face.

As shown in FIG. 4, the right-angled prism 34 is disposed such that the center of the exit end 33 is aligned with the axis L.

The driving part 4 rotationally drives the light guiding unit 3 based on a control signal from the light-source-system controller 7.

As shown in FIG. 1, the driving part 4 includes a rotary motor 41 and the holding part 42 that rotationally drive the light guiding unit 3 about the axis L and a rotary phase sensor 43 that detects the rotary phase of the light guiding unit 3.

The rotary motor 41 is rotationally controlled by the driving part 4, to be described later, to rotationally drive the light guiding unit 3 via the holding part 42 and is disposed on the axis L. The holding part 42 is disposed on the axis L between the rotary motor 41 and the right-angled prism 34 of the light guiding unit 3 and is supported rotatably about the axis L.

The rotary phase sensor 43 detects the rotary phase of the rotary motor 41 or the holding part 42, thereby detecting the rotary phase of the light guiding unit 3. In other words, the rotary phase sensor 43 detects the rotary phase of the entrance end 31. The rotary phase sensor 43 is electrically connected to a sensor driving part 73, is driven by the sensor driving part 73, and outputs a detection signal to the sensor driving part 73.

As shown in FIGS. 1 and 4, the reflection plates 5 are ring-plate-like members that reflect to the light guiding unit 3 illumination light leaking in the axis L direction from the light source units 2. Specifically, they are ring-plate-like members extending from an area adjacent to the entrance end 31 toward the light source units 2, with the axis L serving as the center.

The reflection plates 5 are disposed at two places close to the rotary motor 41 and close to the exit end 33, with predetermined gaps in the axis L direction with respect to the light source units 2 and the parallel rod 32. Surfaces of the reflection plates 5 that face the light source units 2 and the parallel rod 32 are formed to have reflecting surfaces for reflecting illumination light.

The light-source-system controller 7 controls the light source units 2 and the driving part 4. As shown in FIG. 2, the light-source-system controller 7 includes the light-source driving part 71 that controls the light source units 2, a motor driving part 72 that controls the rotary motor 41 of the driving part 4, and the sensor driving part 73 that controls the rotary phase sensor 43.

The light-source driving part 71 controls emission of illumination light in the light source units 2 based on control signals from the light-source-system controller 7. Specifically, the light-source driving part 71 controls power to be supplied to the LED 22 of each of the light source units 2 to control the on/off state of the LED 22.

The motor driving part 72 controls rotation of the rotary motor 41 based on a control signal from the light-source-system controller 7. For example, when a stepping motor is used as the rotary motor 41, the motor driving part 72 uses a known control method to control the rotation and halting of the rotary motor 41 and also to control the rotary phase thereof.

The sensor driving part 73 drives the rotary phase sensor 43 based on a control signal from the light-source-system controller 7 and also outputs a detection signal output from the rotary phase sensor 43 to the light-source-system controller 7.

The light-source-system controller 7 outputs to the light-source driving part 71 control signals for controlling the on/off state of the respective light source units 2, based on the detection signal received from the sensor driving part 73. The method of controlling the on/off state of the respective light source units 2 will be described below in detail.

Next, an illumination method used in the illumination apparatus 1, having the above-described structure, will be described.

As shown in FIG. 2, the light-source-system controller 7 outputs to the motor driving part 72 a control signal for rotationally driving the rotary motor 41 and also detects the rotary phase of the entrance end 31 (see FIG. 4) via the sensor driving part 73.

After detecting the rotary phase, the light-source-system controller 7 determines the light source units 2 that face the entrance end 31 and outputs to the light-source driving part 71 control signals for causing the determined light source units 2 to emit illumination light.

The light-source driving part 71 supplies power to the light source units 2 based on the received control signals.

When power is supplied, the LED 22 of each of the light source units 2 emits illumination light, as shown in FIG. 3. In this embodiment, the LEDs 22 of the light source units 2 that face the entrance end 31 and that are arrayed in 4 columns in the circumferential direction emit illumination light. In short, 16 (4 rows×4 columns) light source units 2 emit illumination light.

Part of the illumination light emitted from the LEDs 22 directly enters the entrance end of the tapered rod 23. The illumination light emitted from the LEDs 22 toward the reflecting members 24 is reflected by the reflecting members 24 to enter the entrance end of the tapered rod 23.

The illumination light entering the tapered rod 23 is reflected by a side surface of the tapered rod 23 to be collimated and emitted from the exit end. As a result of the collimation in the tapered rod 23, the illumination light is collimated more than when emitted from the LEDs 22.

In the direction along the axis L, part of the illumination light emitted from the tapered rod 23 directly enters the entrance end 31, as shown in FIG. 1. On the other hand, light leaking in the axis L direction from between the tapered rod 23 and the entrance end 31 is incident on the reflection plates 5 to be reflected toward the entrance end 31.

On the other hand, in a plane perpendicular to the axis L, illumination light beams emitted from the light source units 2 that face the entrance end 31 respectively travel toward the axis L and enter the entrance end 31, as shown in FIG. 4. Since the entrance end 31 is formed in a cylindrical lens shape, the illumination light is refracted by the entrance end 31 and is changed to light traveling along the optical axis of the parallel rod 32, in other words, to be collimated.

FIG. 6 is a schematic view for explaining a case where the light source units are arranged on a plane.

When the light source units 2 are arrayed on the cylindrical surface as described above, this is equivalent to a case where illumination light emitted from the light source units 2 enters the entrance end 31 having a narrower area than the total area of the exit ends of the light source units 2, as shown in FIG. 6.

Specifically, when the light source units 2 are arrayed on the cylindrical surface, emitted illumination light travels (is collected) toward the axis L to enter the entrance end 31, as shown in FIG. 5. Therefore, all of the illumination light enters the entrance end 31 of the light guiding unit 3, whose area is narrower than the total area of the exit ends of the light source units 2 disposed in 4 columns.

The illumination light entering the parallel rod 32 enters the right-angled prism 34 from the parallel rod 32 to be reflected by the reflective coating 35 in the direction along the axis L. The reflected illumination light is emitted from the exit end 33 toward an illumination object.

Next, the sequence for turning on the light source units 2, performed by the light-source-system controller 7, will be described.

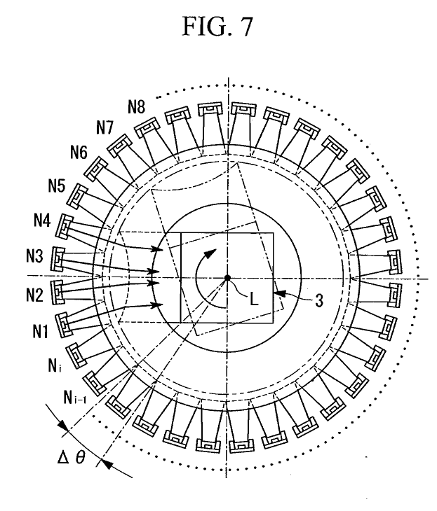

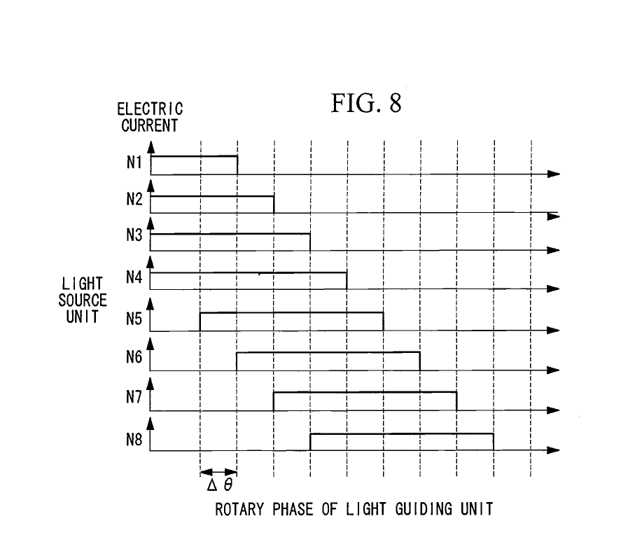

FIG. 7 is a schematic view for explaining the sequence for turning on the light source units shown in FIG. 1. FIG. 8 is a graph for explaining the sequence for turning on the light source units shown in FIG. 1.

As shown in FIG. 6, it is assumed that the columns of the light source units 2 that face the entrance end 31 at a certain point in time are referred to as N1, N2, N3, . . . , Nᵢ₋₁, and Nᵢ (i=32) in a clockwise direction, and it is defined that the angle for the light source units 2 disposed in one column with respect to the axis L is Δθ. In this embodiment, Δθ=360°/32=11.25°.

In this case, the sequence for turning on the light source units 2 in columns is shown in FIG. 8.

In FIG. 8, the position of the light guiding unit 3 shown in FIG. 7 (the position thereof facing leftward in FIG. 7) is set to a phase of 0°, and the timing of turning on the light source units 2 in each column with respect to the rotary phase of the light guiding unit 3 is shown.

When the phase of the light guiding unit 3 is 0°, the light-source-system controller 7 outputs control signals for turning on the light source units 2 in columns N1 to N4, as shown in FIG. 8 (see FIG. 2).

When the phase of the light guiding unit 3 advances from 0° by Δθ, the light-source-system controller 7 outputs a control signal for turning off the light source units 2 in column N1 and also outputs a control signal for turning on the light source units 2 in column N5.

Thereafter, every time the phase of the light guiding unit 3 advances by Δθ, the light-source-system controller 7 outputs control signals for turning off and on the light source units 2 in the corresponding columns.

According to the above-described structure, respective illumination light beams emitted from the plurality of light source units 2 travel toward the axis L of the circle or the cylindrical surface and enter the entrance end 31 of the light guiding unit 3 disposed facing the light source units 2. Since the entrance end 31 is formed in a concave surface shape having the focal point on the axis L, in other words, it is formed in a cylindrical lens shape, the respective illumination light beams entering from the entrance end 31 are substantially collimated through refraction by the entrance end 31. Therefore, according to the illumination apparatus 1 of this embodiment, highly-directional illumination light can be emitted from the exit end 33 of the light guiding unit 3.

Further, since the plurality of light source units 2 are arrayed in a circle or on the cylindrical surface, it is possible to allow illumination light emitted from more light source units 2 to enter the entrance end 31 having the same area to increase the amount of the illumination light emitted from the exit end 33, compared with a case where they are arranged linearly or on a plane.

The light guiding unit 3 is rotationally driven about the axis L, thereby switching and changing over the light source units 2 that face the entrance end 31, at high speed. Illumination light emitted from the light source units 2 that face the entrance end 31 enters the light guiding unit 3 from the entrance end 31. The illumination light entering the light guiding unit 3 from the entrance end 31 is reflected by the prism in the axis L direction and is emitted from the exit end 33 in the axis L direction.

Since the light source units 2 that face the entrance end 31 are switched and changed over at high speed, it is possible to suppress variations of illumination light occurring during the switching and changeover and to generate stable illumination light in which optical loss is low when guided from the light source units 2 in the direction of illumination.

Since the reflection plates 5 are formed in a ring-plate-like shape, illumination light leaking in the axis L direction from between the entrance end 31 that is rotating and the light source units 2 that face the entrance end 31 can be reflected by the reflection plates 5 and guided to the entrance end 31. Therefore, it is possible to generate stable illumination light in which optical loss is low when guided from the light source units 2 in the direction of illumination.

Since the light source units 2, that is, the LEDs 22, are turned on only during a period when they face the entrance end and are turned off during the other periods, in other words, they are driven by high current pulses to emit light, it is possible to emit a large amount of illumination light from the LEDs 22 without increasing the emission area, compared with a case where the LEDs 22 are driven by direct current.

Since the light source unit 2 is provided with the LED 22 and the tapered rod 23, it is possible to guide illumination light emitted from the LED 22 to the entrance end 31 of the light guiding unit 3 while suppressing optical loss.

Further, compared with a case where the tapered rod 23 is not used, the illumination light emitted from the LED 22 can be collimated more, to be guided to the entrance end 31 of the light guiding unit 3.

Since the light guiding unit 3 is provided with the parallel rod 32, it is possible to guide the illumination light entering the light guiding unit 3 from the entrance end 31, to the exit end 33 while suppressing optical loss.

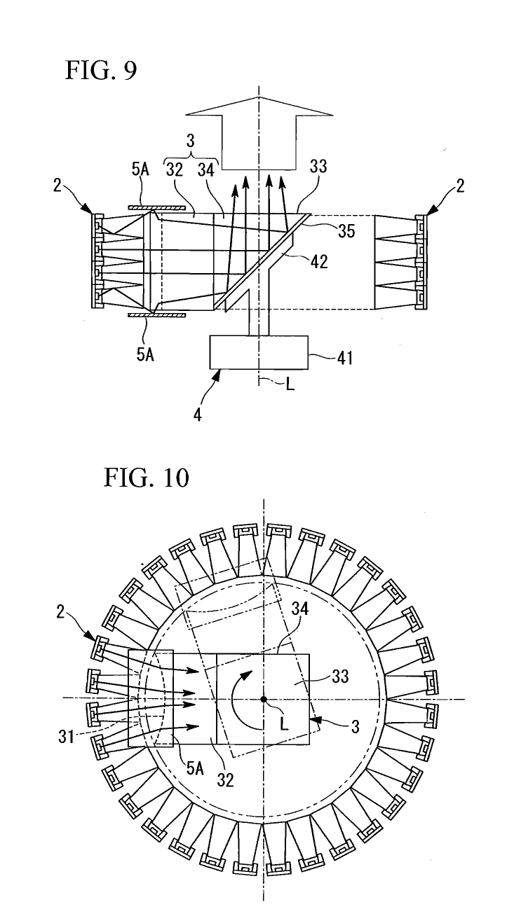

FIG. 9 is a schematic view for explaining another embodiment of the illumination apparatus shown in FIG. 1. FIG. 10 is a top view for explaining an illumination apparatus shown in FIG. 9 according to the other embodiment.

Note that, although an example case where the reflection plates 5 are formed in a ring-plate-like shape as in the above embodiment has been described, the shape of the reflection plates 5 is not limited to a ring-plate-like shape, and rectangular reflection plates (reflecting parts) 5A may be used, as shown in FIGS. 9 and 10; the shape thereof is not particularly limited.

The embodiment shown in FIGS. 9 and 10 has a configuration in which the reflection plates 5A are rotationally driven together with the light guiding unit 3. The reflection plates 5A can reflect and guide to the entrance end 31 illumination light leaking in the axis L direction from between the entrance end 31 that is rotating and the light source units 2 that face the entrance end 31.

### Second Embodiment

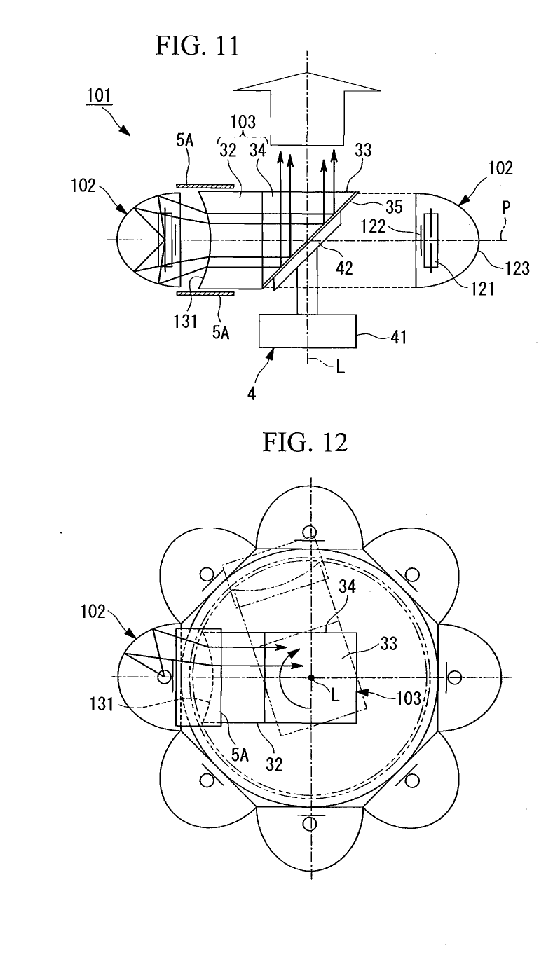

Next, an illumination apparatus according to a second embodiment of the present invention will be described with reference to FIGS. 11 to 13.

Although the basic structure of the illumination apparatus according to this embodiment is the same as that of the first embodiment, the structures of a light source unit and a light guiding unit are different from those of the first embodiment. Therefore, in this embodiment, only the structures of the light source unit and the light guiding unit will be described with reference to FIGS. 11 to 13, and a description of the other components etc. will be omitted.

FIG. 11 is a schematic view for explaining the structure of the illumination apparatus according to this embodiment. FIG. 12 is a top view for explaining the structure of the illumination apparatus shown in FIG. 11.

Note that identical reference symbols are assigned to the same components as those in the first embodiment, and a description thereof will be omitted.

As shown in FIGS. 11 and 12, an illumination apparatus 101 includes a plurality of light source units (light sources) 102 that emit illumination light, a light guiding unit (light guiding means) 103 that guides the emitted illumination light, the driving part 4 that rotationally drives the light guiding unit 103, the reflection plates 5A that reflect to the light guiding unit 103 illumination light leaking from the light source units 102, and the light-source-system controller 7 (see FIG. 2) that controls the light source units 102 and the driving part 4.

As shown in FIG. 11, each of the light source units 102 includes a xenon tube 121 that emits illumination light and a light-source reflection plate 122 and a reflector 123 that reflect the emitted illumination light.

The xenon tube 121 emits illumination light based on power supplied from the driving part 4 (see FIG. 2). The xenon tube 121 has a substantially columnar shape extending along the axis L and is disposed between the light-source reflection plate 122 and the reflector 123. More specifically, the xenon tube 121 is disposed such that a light emitting part thereof is located on a layout plane P of the light source unit 102, to be described later.

The light-source reflection plate 122 and the reflector 123 reflect illumination light emitted from the xenon tube 121 toward the axis L.

The light-source reflection plate 122 is disposed between the xenon tube 121 and the light guiding unit 103 and reflects the illumination light emitted from the xenon tube 121 toward the reflector 123.

The reflector 123 has a shape obtained when part of an ellipse in which the light emitting part of the xenon tube 121 serves as one focal point and the intersection of the layout plane P, to be described later, with the axis L serves as another focal point is rotated about an axis that includes the focal point and the other focal point. In other words, the reflector 123 is formed in a shape that covers the xenon tube 121, serving as the focal point, and that opens toward the axis L that includes the other focal point. The inner circumferential surface of the reflector 123 serves as a reflecting surface for reflecting the illumination light.

The light source units 102 are arrayed on the circumference with the axis L serving as the center and on the layout plane P, which is a plane perpendicular to the axis L. In this embodiment, a description will be given of an example case where eight light source units are arrayed.

As shown in FIGS. 11 and 12, the light guiding unit 103 includes the parallel rod 32 provided with an entrance end 131 and the right-angled prism 34 provided with the exit end 33.

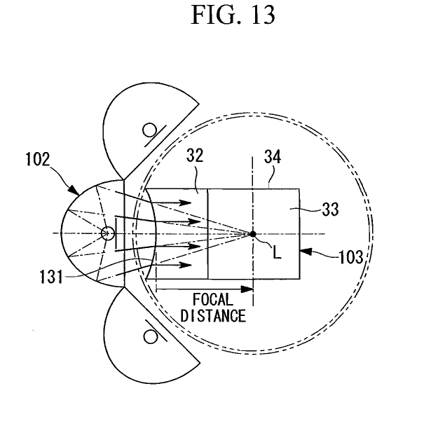

FIG. 13 is a partially enlarged view for explaining the structure of the entrance end of the light guiding unit shown in FIG. 11.

At an end of the parallel rod 32 facing the light source unit 102, the entrance end 131 is formed, which illumination light emitted from the light source unit 102 facing the end enters. As shown in FIG. 13, the entrance end 131 is formed to have a concave-curved surface having the focal point on the intersection of the axis L with the layout plane P, in other words, it is formed in a concave lens shape.

As shown in FIG. 13, the area of the entrance end 131 is set smaller than the area of an opening part of the reflector 123 facing the entrance end 131. Specifically, the end of the entrance end 131 is located on a straight line connecting the end of the opening part of the reflector 123 to the intersection of the axis L with the layout plane P.

Next, an illumination method used in the illumination apparatus 101, having the above-described structure, will be described.

As in the first embodiment, power is supplied to the light source unit 102 that faces the entrance end 131, and the xenon tube 121 to which the power has been supplied emits illumination light.

The illumination light that is emitted from the xenon tube 121 and that is incident on the light-source reflection plate 122 is reflected by the light-source reflection plate 122 toward the reflector 123 and is reflected by the reflector 123 toward the intersection of the axis L with the layout plane P.

On the other hand, the illumination light that is directly incident on the reflector 123 from the xenon tube 121 is also reflected by the reflector 123 toward the above-mentioned intersection.

The illumination light reflected by the reflector 123 is emitted from the light source unit 102 and enters the entrance end 131 of the light guiding unit 103. On the other hand, the illumination light beams leaking in the axis L direction from between the light source unit 102 and the entrance end 131 are incident on the reflection plates 5A and are reflected toward the entrance end 131.

As shown in FIGS. 11 and 12, the illumination light beams emitted from each light source unit 102 that faces the entrance end 131 respectively travel toward the intersection of the axis L with the layout plane P to enter the entrance end 131. Since the entrance end 131 is formed in a concave lens shape, the illumination light is refracted by the entrance end 131 and is changed to light traveling along the optical axis of the parallel rod 32, in short, to be collimated.

The illumination light entering the parallel rod 32 enters the right-angled prism 34 from the parallel rod 32 and is reflected by the reflective coating 35 toward the direction along the axis L. The reflected illumination light is emitted from the exit end 33 toward an illumination object.

Since the sequence for turning on the light source units 102, performed by the light-source-system controller 7, is the same as that in the first embodiment, a description thereof will be omitted.

### Third Embodiment

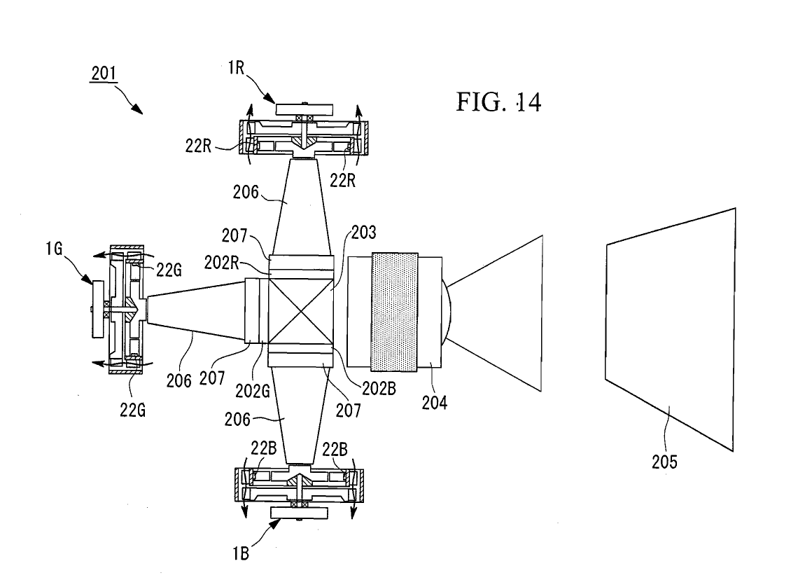

Next, a projector according to a third embodiment of the present invention will be described with reference to FIG. 14.

FIG. 14 is a schematic view for explaining the structure of the projector according to this embodiment.

A projector 201 of this embodiment projects an image onto a screen 205 by using the illumination apparatus 1 of the first embodiment.

As shown in FIG. 14, the projector 201 includes illumination apparatuses 1R, 1G, and 1B that respectively emit red, green, and blue illumination light, liquid crystal display devices (display devices) 202R, 202G, and 202B that respectively modulate the illumination light of the respective colors emitted from the illumination apparatuses, a dichroic cross-prism 203 that combines the modulated light of the respective colors, and a projector lens (projection optics means) 204 that projects the combined modulated light on the screen 205.

The illumination apparatuses 1R, 1G, and 1B are provided with LEDs (light emitting parts) 22R, 22G, and 22B that respectively emit red, green, and blue illumination light beams.

As shown in FIG. 14, the illumination apparatuses 1R, 1G, and 1B are arranged at intervals of approximately 90 degrees in phase in a counterclockwise direction (in a counterclockwise direction in FIG. 14) around the dichroic cross-prism 203.

The liquid crystal display devices 202R, 202G, and 202B are arranged respectively facing the illumination apparatuses 1R, 1G, and 1B, and tapered rods 206 and polarization conversion elements 207 are disposed between the liquid crystal display devices 202R, 202G, and 202B and the illumination apparatuses 1R, 1G, and 1B.

The tapered rods 206 guide the illumination light of the respective colors emitted from the illumination apparatuses 1R, 1G, and 1B to the polarization conversion elements 207 and the liquid crystal display devices 202R, 202G, and 202B. In the tapered rods 206, the ends thereof close to the illumination apparatuses 1R, 1G, and 1B have areas smaller than the ends thereof close to the polarization conversion elements 207.

Of linearly-polarized light beams that are perpendicular to each other, the polarization conversion elements 207 allow one linearly-polarized light beam to pass through and block the other linearly-polarized light beam. The polarization conversion elements 207 are disposed between the liquid crystal display devices 202R, 202G, and 202B and the tapered rods 206.

The liquid crystal display devices 202R, 202G, and 202B generate modulated light by modulating the illumination light of the respective colors, based on externally received image data. The liquid crystal display devices 202R, 202G, and 202B are disposed between the dichroic cross-prism 203 and the polarization conversion elements 207.

Note that known polarization conversion elements and liquid crystal display devices can be used as the polarization conversion elements 207 and the liquid crystal display devices 202R, 202G, and 202B, and the types and forms thereof are not particularly limited.

The dichroic cross-prism 203 is a prism-shaped optical member that combines the modulated light of the respective colors generated by the liquid crystal display devices 202R, 202G, and 202B, to generate modulated light for displaying a color image.

The dichroic cross-prism 203 is disposed at a location surrounded by the liquid crystal display devices 202R, 202G, and 202B and the projector lens 204.

A red-light reflecting surface and a green-light reflecting surface that are diagonally disposed are formed in the dichroic cross-prism 203.

The red-light reflecting surface reflects only red illumination light and allows illumination light of the other wavelengths to pass therethrough. The red-light reflecting surface approaches the projector lens 204 from the illumination apparatus 1R toward the illumination apparatus 1B.

On the other hand, the green-light reflecting surface only reflects green illumination light and allows illumination light of the other wavelengths to pass therethrough. The green-light reflecting surface approaches the projector lens 204 from the illumination apparatus 1B toward the illumination apparatus 1R.

The projector lens 204 is disposed at a location to sandwich the dichroic cross-prism 203 with the liquid crystal display device 202G. A known lens system can be used as the projector lens 204, and the type thereof is not particularly limited.

Next, image projection performed in the projector 201, having the above-described structure, will be described.

In order to project an image on the screen 205, the illumination apparatuses 1R, 1G, and 1B respectively emit illumination light of red, green, and blue, as shown in FIG. 14.

Since an illumination-light emitting method used in the illumination apparatuses 1R, 1G, and 1B is the same as that in the first embodiment, a description thereof will be omitted.

The illumination light beams of the respective colors emitted from the illumination apparatuses 1R, 1G, and 1B enter the tapered rods 206, are collimated, and then enter the polarization conversion elements 207. Of linearly-polarized light beams that are perpendicular to each other in the entering illumination light of each color, the polarization conversion elements 207 allow only one linearly-polarized light beam (for example, p polarized light beam) to pass through.

The linearly-polarized light beams in the illumination light of the respective colors that have passed through the polarization conversion elements 207 respectively enter the liquid crystal display devices 202R, 202G, and 202B. The liquid crystal display devices 202R, 202G, and 202B respectively modulate the illumination light to generate modulated light based on externally received image data. The modulated light beams of the respective colors generated by the liquid crystal display devices 202R, 202G, and 202B enter the dichroic cross-prism 203.

The dichroic cross-prism 203 combines the entering modulated light beams of the respective colors to generate modulated light for displaying a color image.

Specifically, the red modulated light enters the dichroic cross-prism 203, is reflected by the red-light reflecting surface therein, and is emitted toward the projector lens 204. The green modulated light enters the dichroic cross-prism 203, passes through the red-light reflecting surface and a blue-light reflecting surface therein, and is emitted toward the projector lens 204. The blue modulated light enters the dichroic cross-prism 203, is reflected by the blue-light reflecting surface, and is emitted toward the projector lens 204.

In this way, the modulated light beams of the respective colors are combined and emitted toward the projector lens 204.

The modulated light emitted from the dichroic cross-prism 203 enters the projector lens 204 and is projected on the screen 205. With the projected modulated light, a color image is displayed on the screen 205.

According to the above-described structure, when the illumination apparatuses 1R, 1G, and 1B of the first embodiment are used, the liquid crystal display devices 202R, 202G, and 202B are stably illuminated with illumination light that has high directivity, high intensity, and low variations in the amount of light. Therefore, the projector 201 of this embodiment can project a bright image with good contrast on the screen 205.

Note that illumination light beams emitted by the illumination apparatuses in the above description are red, blue, and green, but the colors are not limited to these, and one illumination apparatus that emits white illumination light may be used, for example, instead of the illumination apparatuses 1R, 1G, and 1B.

In this case, the dichroic cross-prism 203 is not required, and modulated light obtained by modulating the white illumination light in the liquid crystal display device is directly projected on the screen by the projector lens.

As described above, even in a projector that uses the illumination apparatus emitting white illumination light, it is possible to project a bright image with good contrast on the screen.

1. An illumination apparatus comprising:
a plurality of light sources that are arranged in an arc and that emit illumination light toward the axis of the arc; and
light guiding means having an entrance end that faces the plurality of light sources and that is formed in a concave surface shape having a focal point on the axis and an exit end from which the illumination light is emitted.

2. An illumination apparatus according to claim 1, further comprising reflecting parts that face end surfaces of the light guiding means in the axis direction, that extend from the entrance end toward the light sources, and whose surfaces facing the light guiding means serve as reflecting surfaces for reflecting light.

3. An illumination apparatus according to claim 1, wherein:
the plurality of light sources are arranged in a circle with the axis serving as the center;
the light guiding means is provided with a prism that is disposed at a location on the axis and that reflects the illumination light entering from the entrance end, in the axis direction; and
rotating means that rotationally drives the light guiding means about the axis is provided.

4. An illumination apparatus according to claim 3, further comprising reflecting parts that face end surfaces of the light guiding means in the axis direction, that extend from the entrance end toward the light sources, and whose surfaces facing the light guiding means serve as reflecting surfaces for reflecting light,
wherein the rotating means rotationally drives the reflecting parts together with the light guiding means.

5. An illumination apparatus according to claim 3, further comprising reflecting parts that face end surfaces of the light guiding means in the axis direction, that extend from the entrance end toward the light sources in the form of a ring plate, and whose surfaces facing the light guiding means serve as reflecting surfaces for reflecting light.

6. An illumination apparatus according to claim 3, wherein the light sources are turned on only during a period of time when they face the entrance end.

7. An illumination apparatus according to claim 1, wherein the light sources each have a light emitting part for emitting illumination light and a tapered rod for guiding the emitted light toward the entrance end.

8. An illumination apparatus according to claim 1, wherein the entrance end has a cylindrical lens.

9. An illumination apparatus according to claim 1, wherein the light guiding means is provided with the entrance end and a parallel rod that guides illumination light to the exit end.

10. An image projection display apparatus comprising:
a plurality of illumination apparatuses according to claim 1 that respectively emit light of different primary colors;
display devices that modulate the illumination light emitted from the illumination apparatuses based on input image data; and
projection optics means that projects the modulated illumination light on a screen.

11. An illumination apparatus comprising:
a plurality of light sources that are arranged in an arc and that emit illumination light toward the axis of the arc; and
light guiding unit having an entrance end that faces the plurality of light sources and that is formed in a concave surface shape having a focal point on the axis and an exit end from which the illumination light is emitted.
